(19) United States
(12) Patent Application Publication
(10) Pub. No.: US 2008/0317574 A1
(43) Pub. Date: Dec. 25, 2008

(54) Swing Drive Device and Work Machine

(75) Inventors: Naoyuki Moriya, Tokyo (JP); Atsushi Wada, Tokyo (JP); Madoka Binnaka, Tokyo (JP)

Correspondence Address: DARBY & DARBY P.C., P.O. BOX 770, Church Street Station, New York, NY, 10008-0770, US

(73) Assignee: SHIN CATERPILLAR MITSUBISHI LTD., Tokyo (JP)

(21) Appl. No.: 11/573,759

(22) PCT Filed: Mar. 2, 2006
(86) PCT No.: PCT/JP2006/303950

§ 371 Date: Feb. 15, 2007

(30) Foreign Application Priority Data
Aug. 24, 2005 (JP) 2005-243102

(51) Int. Cl. B66C 23/06

(52) U.S. Cl. 414/687; 212/232

(57) ABSTRACT

The invention provides a swing drive device that is capable of energy conservation by limiting loss of hydraulic fluid pressure energy resulting from discharge of the hydraulic fluid pressure energy as thermal energy into the air during acceleration or deceleration of swinging action and transforming motion energy to electric energy during deceleration of swinging action, and also enables cost reduction by making components and parts compact.

### TECHNICAL FIELD

The present invention relates to a swing drive device adapted to be operated by hydraulic fluid pressure energy and electric energy. The present invention also relates to a work machine equipped with such a swing drive device.

### BACKGROUND ART

FIG. 2 shows a swing type work machine 10, which is a hydraulic excavator. The work machine 10 has a machine body including a lower structure 11 and an upper structure 12, which is revolvably mounted on the lower structure 11. A cab 14 and a work equipment 15 are mounted on the machine body 13. The work equipment 15 includes a boom 16, an arm connected to the distal end of the boom 16, and a bucket connected to the distal end of the arm 17. The boom 16 is adapted to be vertically pivoted by boom cylinders 16c. The arm 17 and the bucket 18 are adapted to be respectively rotated by a stick cylinder 17c and a bucket cylinder 18c.

A swing system hydraulic circuit for rotating the upper structure 12 on the lower structure 11 of the work machine that has a structure described above has a configuration shown in FIG. 3, wherein a discharge passage of an oil hydraulic pump 21 mounted on the upper structure 12 and a return passage to a tank 22 are respectively connected to a supply port and a return port of a control valve 23, and two swing passages 24,25 drawn out from the control valve 23 are connected to an oil hydraulic motor 26. The aforementioned control valve 23 is adapted to be pilot-operated by means of a hydraulic remote control valve 23a, which is linked with an operation lever in an interlocking relationship. The oil hydraulic motor 26 is adapted to be driven by the pressure of the hydraulic oil supplied from the oil hydraulic pump 21 through the control valve 23 and the swing passage 24 so that the oil hydraulic motor 26 rotates the upper structure 12 by means of a swing unit 27, which is comprised of reduction gears, etc., thereby performing swinging action.

The swing system hydraulic circuit shown in FIG. 3 has a configuration such that when accelerating swinging action, a relief valve 28A incorporated in the oil hydraulic motor 26 controls the load pressure to the oil hydraulic motor 26 at a constant level in order to achieve smooth acceleration while protecting the oil hydraulic motor 26 from excessive load pressure. At that time, the relief valve 28A transforms hydraulic energy that corresponds to a differential pressure between the upstream and downstream sides of the relief valve 28A as well as the flow rate of the hydraulic oil therethrough to thermal energy. Although the return oil from the relief valve 28A is recovered into the tank 22 through an oil cooler 29 for cooling the hydraulic oil, the thermal energy generated at the relief valve 28A is discharged into the air when the oil passes through the oil cooler 29, resulting in energy loss. Such energy loss is substantial when conducting swinging operation alone.

During tandem operation, such as when raising the boom by extending the boom cylinders 16c in sync with swinging operation, discharge pressure from the oil hydraulic pump 21 does not increase to the same extent as that for swinging operation alone, because the discharge flow from the oil hydraulic pump 21 is partly consumed by the boom-up operation, which imposes a lesser burden. In other words, nearly all the output of the oil hydraulic pump 21 is fed to the boom cylinders 16c, while the output to the oil hydraulic motor 26 is limited. Therefore, loss of energy from the relief valve 28A is small.

During deceleration of swinging action, the load pressure to the oil hydraulic motor 26 is controlled at a constant level by applying braking force by means of a relief valve 28B in order to achieve smooth deceleration while protecting the oil hydraulic motor 26 from excessive load pressure. At that time, too, the relief valve 28B transforms hydraulic energy to thermal energy in the same manner as it does during acceleration, and the thermal energy is discharged into the air through the oil cooler 29, resulting in energy loss.

Such energy loss is shown in FIG. 4. FIG. 4 (a) shows changes in degree of lever movement when operating the hydraulic remote control valve 23a with a lever. In other words, FIG. 4 (a) shows changes in pilot pressure applied from the hydraulic remote control valve 23a to the control valve 23. FIG. 4 (b) shows changes in pump output of the oil hydraulic pump 21 resulting from changeover of the control valve 23, as well as changes in motor output of the oil hydraulic motor 26. A difference between a pump output and a motor output indicates energy loss. FIG. 4 (c) shows losses from the relief valve 28A and losses from the relief valve 28B.

In order to reduce or limit energy loss that occurs when rotating the upper structure 12 by the oil hydraulic motor 26, there has been provided a system that uses an electric motor in the place of an oil hydraulic motor 26 in order to limit generation of thermal energy during acceleration of swinging action and, during deceleration of swinging action, drive the electric motor as a generator so as to transform swinging motion energy, i.e. energy of rotation motion of the upper structure 12, to electric energy, thereby reducing energy loss. Examples of such a system are described in Patent Reference Documents 1 and 2.

Patent Reference Document 1: Japanese Laid-open Patent Publication No. 2001-12274 (page 6, FIGS. 4 and 5)

Patent Reference Document 2: Japanese Laid-open Patent Publication No. 2004-190845 (pages 13-16, FIGS. 6-8)

### DISCLOSURE OF THE INVENTION

### Problems to be Solved by the Invention

As described above, in trying to appropriately accelerate or slow down a hydraulic fluid pressure motor to achieve smooth acceleration or deceleration, there is a problem of energy loss that results from hydraulic fluid pressure energy being transformed to thermal energy and discharged into the air deceleration. On the other hand, achieving satisfactory acceleration or deceleration characteristics solely by an electric motor presents a problem in that cost increase is inevitable, because such a system requires a large-size electric motor with a great capacity.

In order to solve the above problems, an object of the invention is to provide a swing drive device that is capable of energy conservation by limiting loss of hydraulic fluid pressure energy resulting from discharge of the hydraulic fluid pressure energy as thermal energy into the air during acceleration or deceleration of swinging action and transforming motion energy to electric energy during deceleration of swinging action, and also enables cost reduction by making components and parts compact. Another object of the invention is to provide a work machine equipped with an efficient system that uses such a swing drive device.

### Means to Solve the Problems

The present invention claimed in claim 1 relates to a swing drive device comprising a hydraulic motor that serves to drive a swing unit to perform swinging action; an electric motor that is connected to the swing unit in such a state as to be connected in parallel with the hydraulic motor and is capable of driving the swing unit simultaneously with the hydraulic motor to perform swinging action; an electric energy storage device that serves to supply electric power to the electric motor and, when the electric motor functions as a generator, store electric power; and a no-load valve that is provided for the hydraulic motor and serves to create a shortcut between an inlet port and an outlet port of the hydraulic motor during fine operation.

The present invention claimed in claim 2 relates to a swing drive device claimed in claim 1, wherein the swing drive device further includes an inverter that serves to enable the electric motor to function as a generator so as to charge the electric energy storage device depending on the level of charge of the electric energy storage device during normal swinging action, in which the swing unit is driven by the hydraulic motor, and make the electric motor function as a generator in order to transform swinging motion energy to electric energy, thereby charging the electric energy storage device during deceleration of swinging action.

The present invention claimed in claim 3 relates to a swing drive device claimed in claim 1 or claim 2, wherein the hydraulic motor is provided with relief valves.

The present invention claimed in claim 4 relates to a work machine comprising a lower structure; an upper structure that is rotatable by a swing drive device claimed in any one of the claims from claim 1 to claim 3; and a work equipment mounted on the upper structure.

### EFFECTS OF THE INVENTION

According to the present invention as claimed in claim 1, the hydraulic motor and the electric motor are capable of simultaneously driving the swing unit. Therefore, when accelerating swinging action, smooth acceleration can be achieved by controlling electric current to the electric motor, thereby enabling energy conservation by reducing loss of the hydraulic energy that is discharged as thermal energy into the air when the load pressure to the hydraulic motor is controlled. During deceleration of swinging action, loss of the hydraulic energy that is discharged as thermal energy into the air when the load pressure to the hydraulic motor is controlled can be reduced by transforming swinging motion energy to electric energy by means of the electric motor and storing the electric energy in the electric energy storage device. Thus, an efficient system can be constructed. Furthermore, the combination of the hydraulic motor and the electric motor enables the components to be made compact, resulting in cost reduction. During fine operation, it is possible to drive the swing unit solely by the electric motor, without actuating the hydraulic motor, by controlling the no-load valve at an open position.

According to the present invention as claimed in claim 2, the inverter is capable of functioning so that the electric motor functions as a generator during normal swinging action and thereby charges the electric energy storage device depending on the level of charge of the electric energy storage device while the hydraulic motor is driving the upper structure and that, during deceleration of swinging action, the electric motor functions as a generator, thereby transforming swinging motion energy to electric energy to charge the electric energy storage device.

According to the present invention as claimed in claim 3, should swinging motion energy during deceleration of swinging action exceed the capacitor of the electric motor as the generator, the relief valves provided for the hydraulic motor function as safety valves, thereby protecting the electric motor.

According to the present invention as claimed in claim 4, the hydraulic motor and the electric motor can be simultaneously driven to rotate the upper structure on the lower structure. Therefore, when accelerating swinging action, i.e. rotation of the upper structure, smooth acceleration can be achieved by controlling electric current to the electric motor, thereby enabling energy conservation, in other words reducing loss of the hydraulic energy that is discharged as thermal energy into the air when the load pressure to the hydraulic motor is controlled. During deceleration of swinging action, i.e. rotation of the upper structure, loss of the hydraulic energy that is discharged as thermal energy into the air when the load pressure to the hydraulic motor is controlled can be reduced by transforming swinging motion energy to electric energy by means of the electric motor and storing the electric energy in the electric energy storage device. Thus, an efficient system can be constructed. Furthermore, as the combination of the hydraulic motor and the electric motor enables the components to be made compact, costs can be reduced, resulting in a reduction in production costs for the work machine.

### BRIEF DESCRIPTION OF THE DRAWINGS

FIG. 1 is a circuit diagram showing a swing drive device according to an embodiment of the present invention.

FIG. 2 is a side view of an example of a work machine according to the present invention.

FIG. 3 is a circuit diagram showing a conventional swing drive device.

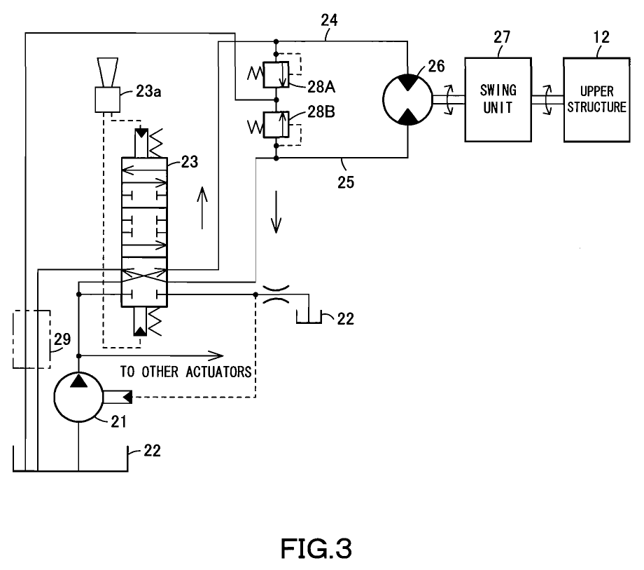

FIG. 4 depicts characteristic diagrams to explain energy loss due to the circuit shown in FIG. 3, of which (a) shows changes in degree of lever movement of a remote control valve; (b) shows changes in pump output and motor output; and (c) shows changes in relief flow rate from relief valves.

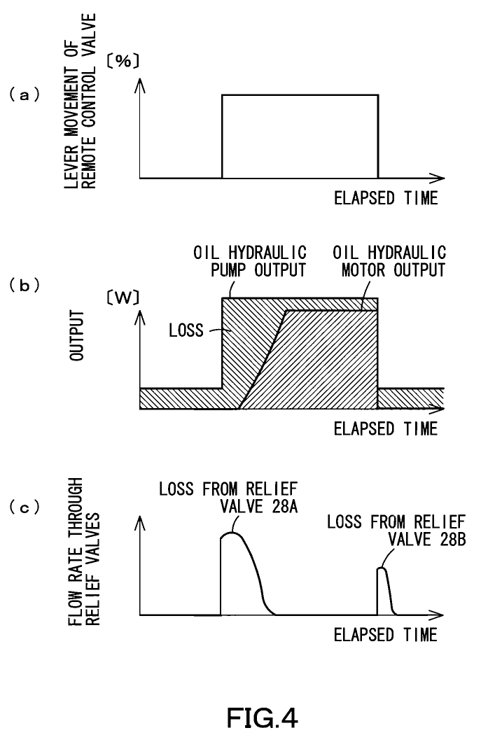

### REFERENCE NUMERALS

10 work machine
11 lower structure
12 upper structure
15 work equipment
30 swing drive device
36 hydraulic motor
37 swing unit
38A,38B relief valve
43 no-load valve
44 electric motor
45 electric energy storage device
46 inverter

### BEST MODE FOR CARRYING OUT THE INVENTION

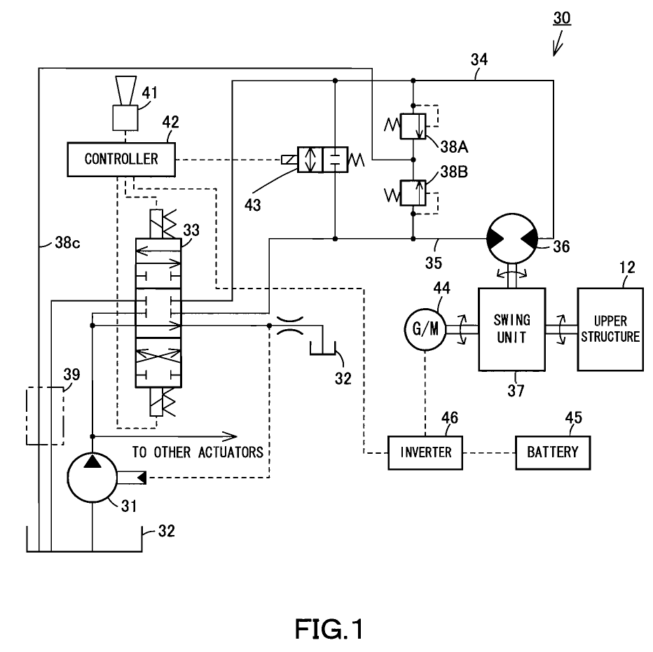

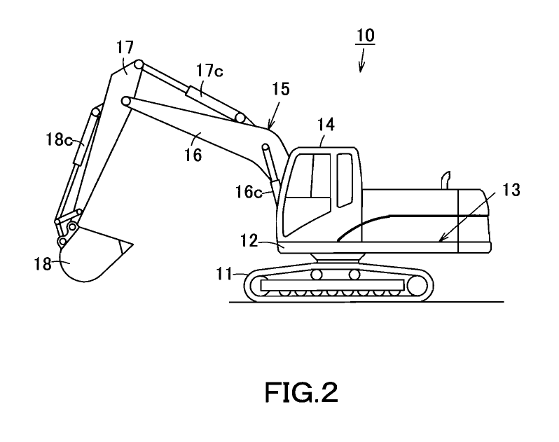

Next, the present invention is explained in detail hereunder, referring to an embodiment thereof shown in FIG. 1. The swing type work machine 10 shown in FIG. 2 also depicts a work machine according to the present invention.

As shown in FIG. 2, an upper structure 12 adapted to be rotated by a swing drive device 30 shown in FIG. 1 is mounted on a lower structure 11. A work equipment 15 is mounted on the upper structure 12. As the work equipment 15 and other components have already been described, their explanations are omitted herein.

The swing drive device 30 shown in FIG. 1 includes a hydraulic fluid pressure circuit, which may be an oil hydraulic circuit. The hydraulic fluid pressure circuit has a hydraulic pump 31 that is mounted on the upper structure and serves as a hydraulic pressure source, such as a pressure oil source. A discharge passage and a return passage of the hydraulic pump 31 are respectively connected to a supply port and a return port of a control valve 33. The aforementioned return passage of the hydraulic pump 31 leads to a tank 32. Two swing passages 34,35 drawn out from the control valve 33 are connected to a hydraulic motor 36, which may be an oil hydraulic motor. The hydraulic motor 36 is adapted to be driven by the pressure of hydraulic fluid, such as hydraulic oil, that is supplied from the hydraulic pump 31 through the control valve 33 and the swing passages 34,35 so that the hydraulic motor 36 rotates the upper structure 12 by means of a swing unit 37, which is comprised of reduction gears, etc.

The hydraulic motor 36 incorporates relief valves 38A,38B, which are disposed between the swing passages 34,35. A return passage 38C from these relief valves 38A,38B and a return passage from the control valve 33 communicate with a tank 32 through an oil cooler 39 for cooling hydraulic oil.

The control valve 33 is adapted to be controlled by means of signals output from a controller 42, which serves to process electric signals input from an input device 41. The input device 41 may be a manually operated joy stick or the like. The control valve 33 functions as a directional control valve for controlling direction of hydraulic fluid, such as hydraulic oil, and a flow control valve for controlling flow rate of the hydraulic fluid. The direction of rotation of the hydraulic motor 36, i.e. normal or reverse, is controlled by the directional control function of the control valve 33, while the rotation speed of the hydraulic motor 36 is controlled by the amount of displacement of the control valve 33.

In association with the hydraulic motor 36, a no-load valve 43 is provided between the swing passages 34,35. The no-load valve 43 is adapted to be actuated by a control signal output from the controller 42 during fine operation of the input device 41 so that the no-load valve 43 shifts to link an inlet port and an outlet port of the hydraulic motor 36 by creating a shortcut between the inlet port and the outlet port.

The swing drive device 30 shown in FIG. 1 has an electric circuit, which includes an electric motor 44, an electric energy storage device 45, and an inverter 46. The electric motor 44 is connected in parallel with the hydraulic motor 36 and, in this state, connected to the swing unit 37 so that the electric motor 44 and the hydraulic motor 36 are capable of simultaneously driving the swing unit 37. The electric energy storage device 45 may be a battery or the like and serves to supply the electric power to the electric motor 44 and, when the electric motor 44 functions as a generator, store electric power. The inverter 46 is disposed between the electric motor 44 and the electric energy storage device 45 and serves to control electric current.

During normal swinging action, i.e. when the swing unit 37 is driven by the hydraulic motor 36, the inverter 46 enables the electric motor 44 to function as a generator in order to charge the electric energy storage device 45 depending on the level of charge of the electric energy storage device 45. During deceleration of swinging action, the inverter 46 enables the electric motor 44 to function as a generator in order to transform swinging motion energy to electric energy, thereby charging the electric energy storage device 45.

As described above, the electric and hydraulic circuits shown in FIG. 1 include the hydraulic motor 36 and the electric motor 44 that are connected in parallel with each other and, in this state, connected to the swing unit 37 so that either is capable of rotating the upper structure 12 through the swing unit 37 independently or by sharing the load simultaneously.

The electric motor 44 has a structure that enables the electric motor 44 to function as a generator by being rotated by an external force or driving torque of the hydraulic motor 36. Electric power obtained from the generator is fed through the inverter 46 and other elements into the electric energy storage device 45 and stored therein. The hydraulic motor 36 and the electric motor 44 both have a structure that is independently capable of rotating the upper structure 12 by means of the swing unit 37, which is comprised of reduction gears, etc., thereby performing swinging action.

The hydraulic motor 36 and the electric motor 44 are both independently capable of outputting separate torque. The hydraulic motor 36 and the electric motor 44 are also capable of independently or in tandem driving the upper structure 12. Furthermore, it is also possible to operate the electric motor 44 as a generator to obtain electric power while driving the upper structure 12 by means of the hydraulic motor 36.

Next, the functions and effects of the embodiment shown in FIG. 1 are explained hereunder.

When a signal commanding swinging action is input from the input device 41, which may be a joy stick or the like, to either one of or both the hydraulic motor 36 or the electric motor 44, the control valve 33 controls upon receiving the command signal the flow rate of the hydraulic fluid to the hydraulic motor 36, thereby driving the hydraulic motor 36.

When the input device 41 outputs the aforementioned command also to the inverter 46, the inverter 46 directs electric current to the electric motor 44 to drive the electric motor 44. The hydraulic motor 36 and the electric motor 44 are also capable of independently or in tandem driving the upper structure 12 through the swing unit 37, which may be comprised of reduction gears, etc.

To be more specific, when it is desired to obtain the maximum output power, the hydraulic motor 36 and the electric motor 44 can be operated in tandem. When an output power is small, such as during fine operation, the output of each component can be reduced; for example, the no-load valve 43 may be controlled at an open position in order to link the swing passages 34,35 by creating a shortcut therebetween, thereby driving the swing unit 37 solely by the electric motor 44, without actuating the hydraulic motor 36.

When the hydraulic motor 36 alone is used as in a conventional case, a part of pump output is wasted as energy loss through the relief valves 38A,38B in order to achieve smooth acceleration. On the other hand, it is possible with the electric motor 44 to reduce the aforementioned energy loss by means of controlling electric current to the electric motor 44 while achieving acceleration characteristics equivalent to those obtained by a conventional device that uses driving power of a hydraulic motor.

During normal swinging action, the inverter 46 is capable of charging the electric energy storage device 45 depending on the level of charge of the electric energy storage device 45 by permitting the electric motor 44 to function as a generator while the hydraulic motor 36 is driving the upper structure 12. For example, when the amount of charge of the electric energy storage device 45 is within a certain threshold amount and the upper structure 12 is rotating at a high speed with a light load, the inverter 46 may function so as to make the electric motor 44 function as a generator to charge the electric energy storage device 45 while driving the upper structure 12 by the hydraulic motor 36.

The configuration according to the embodiment is particularly effective in deceleration of swinging action, because it is possible to reduce energy loss from the relief valves 38A,38B compared with conventional configurations by transforming swinging motion energy to electric energy to charge the electric energy storage device 45 while driving the electric motor 44 as a generator and controlling output from the generator so as to achieve desirable acceleration characteristics.

In cases where the swinging motion energy during deceleration of swinging action exceeds the capacitor of the electric motor 44 as the generator, resulting in the swing braking torque exceeding the capacitor of the generator, the electric motor 44 can be protected by changing over the no-load valve 43 into the closed position shown in FIG. 1 to enable the relief valves 38A,38B of the hydraulic motor 36 to function as safety valves.

According to the configuration described above, the hydraulic motor 36 and the electric motor 44 can be simultaneously driven to rotate the upper structure 12 on the lower structure 11. Therefore, when accelerating swinging action, i.e. rotation of the upper structure 12, smooth acceleration can be achieved by controlling electric current to the electric motor 44, thereby enabling energy conservation, in other words reducing loss of the hydraulic energy that is discharged as thermal energy into the air

1. A swing drive device comprising:
a hydraulic motor that serves to drive a swing unit to perform swinging action;
an electric motor connected to said swing unit in such a state as to be connected in parallel with said hydraulic motor so that said electric motor and said hydraulic motor are capable of driving said swing unit simultaneously to perform swinging action;
an electric energy storage device that serves to supply electric power to said electric motor and, when said electric motor functions as a generator, store electric power; and
a no-load valve that is provided for said hydraulic motor and serves to create a shortcut between an inlet port and an outlet port of said hydraulic motor during fine operation.

2. A swing drive device as claimed in claim 1, wherein:
said swing drive device further includes an inverter that serves to enable said electric motor to function as a generator so as to charge said electric energy storage device depending on a level of charge of said electric energy storage device during normal swinging action, in which said swing unit is driven by said hydraulic motor, and make said electric motor function as a generator in order to transform swinging motion energy to electric energy, thereby charging said electric energy storage device during deceleration of swinging action.

3. A swing drive device as claimed in claim 1, wherein:
said hydraulic motor is provided with relief valves.

4. A work machine comprising:
a lower structure;
an upper structure that is rotatable by a swing drive device claimed in claim 1; and
a work equipment mounted on said upper structure.

5. A swing drive device as claimed in claim 2, wherein:
said hydraulic motor is provided with relief valves.

6. A work machine comprising:
a lower structure;
an upper structure that is rotatable by a swing drive device claimed in claim 2 and
a work equipment mounted on said upper structure.

7. A work machine comprising:
a lower structure;
an upper structure that is rotatable by a swing drive device claimed in claim 3 and
a work equipment mounted on said upper structure.
